(19) United States
(12) Patent Application Publication
(10) Pub. No.: US 2013/0050410 A1
(43) Pub. Date: Feb. 28, 2013

(54) APPARATUS AND METHOD FOR DETERMINING THE 3D COORDINATES OF AN OBJECT AND FOR CALIBRATING AN INDUSTRIAL ROBOT

(71) Applicants: Marcus Steinbichler, Neubeuern (DE); Thomas Mayer, Kolbermoor (DE); Herbert Daxauer, Walchsee (AT)

(72) Inventors: Marcus Steinbichler, Neubeuern (DE); Thomas Mayer, Kolbermoor (DE); Herbert Daxauer, Walchsee (AT)

(73) Assignee: Steinbichler Optotechnik GmbH, Neubeuern (DE)

(21) Appl. No.: 13/397,056

(22) Filed: Feb. 15, 2012

(30) Foreign Application Priority Data
Feb. 16, 2011 (DE) 102011011360.6

(51) Int. Cl. H04N 13/00

(52) U.S. Cl. 348/42; 348/E13.074

(57) ABSTRACT

An improved apparatus for determining the 3D coordinates of an object (1) includes a projector (10) for projecting a pattern onto the object (1), a camera (11) connected to the projector (10) for taking the object (1), and a reference camera (16) connected to the projector (10) and to the camera (11) for taking one or more reference marks (6, 24) of a field (25) of reference marks (only FIGURE).

### BACKGROUND OF THE INVENTION

The invention relates to an apparatus for determining the 3D coordinates of an object and to a method for determining the 3D coordinates of an object. The invention furthermore relates to a method for calibrating an industrial robot.

In an already known method for determining the 3D coordinates of an object, the object is taken using a light fringe projection system. The light fringe projection system includes a projector for projecting a light fringe pattern onto the object and a camera for taking the light fringe pattern radiated back from the object. The shot is evaluated by an evaluation system which includes a computer, in particular a PC.

Since a single shot is as a rule not sufficient to satisfy the measuring demands and/or to detect the object completely in order to determine the 3D coordinates of the object, it is necessary to position the light fringe projection system at different taking positions in space and to transfer the shots taken there into a common, higher ranking coordinate system which can also be called an absolute coordinate system. This process, frequently called “global registration”, requires a high accuracy.

In an already known method of this kind, shots are taken which overlap in part. These shots can be optimized with respect to one another via an optimization of the overlap regions. The method is, however, possibly not sufficiently accurate with larger objects with little surface structure. The additional use of collimating marks which are applied to the object in the overlap regions and which form tie points also frequently does not provide any sufficient improvement.

Methods are furthermore known in which collimating marks are used which are applied to the object and/or to one or more probes surrounding the object. The collimating marks are first calibrated. This preferably takes place using the process of photogrammetry. The different shots of the object can be transformed to the calibrated points with the aid of the collimating marks which are detected by a light fringe projection system so that a global registration is possible.

A method is known from EP 2 273 229 A1 in which a light fringe pattern is projected onto an object by a projector for determining the 3D coordinates of the object. The light fringe pattern reflected by the object is taken by a camera which includes an optical system and an area sensor, in particular a CCD sensor or a CMOS sensor. The projector and the camera form a light fringe projection system. A plurality of reference probes which each have a plurality of reference marks are arranged in the vicinity of the object. The reference probes are first measured. Subsequently the 3D coordinates of the object are determined by the light fringe projection system.

It is as a rule also not sufficient in the determination of the 3D coordinates of an object in accordance with the method of EP 2 273 229 A1 to take only one shot since the object or the region of interest of the object is larger than the field of view of the camera. It is accordingly necessary to position the light fringe projection system comprising the projector and the camera at different positions. The shots taken at the respective position are subsequently transferred into a common, higher ranking coordinate system.

The method in accordance with EP 2 273 229 A1 is, however, frequently associated with a not insubstantial effort, in particular when this method should be carried out in automated measurement system which is integrated into a production process. It is advantageous in such systems to use an industrial robot for positioning the light fringe projection system comprising the projector and camera. The positional information of the robot can then be used as an approximate value for the determination of the location and orientation of the light fringe projection system. The accuracy of this robot position information is, however, as a rule not sufficient for the purposes of global registration.

A further disadvantage arises when the 3D coordinates of objects of different kinds should be determined using the method in accordance with EP 2 273 229 A1. In this case, different probes adapted to the respective size of the object have to be set up and calibrated for each kind of object.

It is furthermore possible that the object whose 3D coordinates should be determined is no longer accessible or is no longer sufficiently accessible due to the placement of the reference probes. The movement paths of the robot can be limited by the reference probes. Furthermore, parts of the object can be masked by the reference probes. The charging of the region surrounded by the reference probes with new objects to be determined can also prove to be difficult.

### SUMMARY OF THE INVENTION

It is the object of the invention to propose an improved apparatus and an improved method for determining the 3D coordinates of an object.

In an apparatus for determining the 3D coordinates of an object, this object is achieved by the features herein. The apparatus includes a projector for projecting a pattern onto the object, a camera connected to the projector for taking the object and a reference camera connected to the projector and to the camera for taking one or more reference marks of a field of reference marks. The pattern projected by the projector is in particular a light fringe pattern. A white light fringe projection is particularly suitable. The camera preferably includes an area sensor, in particular a CCD sensor, a CMOS sensor or another area sensor. It is advantageous if the camera includes an optical system. The camera can be indirectly or directly connected to the projector. It is aligned such that it can take the pattern radiated from the object. The reference camera is indirectly or directly connected to the projector and to the camera. Its location and orientation is fixed with respect to the projector and the camera. The projector, the camera and the reference camera form a measurement system for determining the 3D coordinates of the object.

Advantageous further developments are described herein.

In accordance with an advantageous further development, the apparatus includes one or more further reference cameras. The one or more further reference cameras are fixed in their location and orientation with respect to the projector, the camera and the first reference camera. They can be indirectly or directly connected to the projector and/or to the camera and/or to the reference camera. It is advantageous if the direction of the optical axis of the further reference camera or of the further reference cameras differs from the direction of the optical axis of the camera and/or of the (first) reference camera and/or of the further reference cameras. Generally, the achievable accuracy is the larger, the more reference cameras are used and/or the more different their optical axes and thus directions of gaze are distributed. It can be advantageous in specific cases if the optical axes of the reference cameras are perpendicular to one another. Three reference cameras can be present, for example, whose optical axes are perpendicular to one another. Other embodiments are, however, also possible.

The reference cameras can be provided at a camera module. They can be releasably or non-releasably fastened to the camera module.

In accordance with a further advantageous development, the apparatus includes an evaluation device for determining the location and/or orientation of the projector and/or of the camera and/or of the one or more reference cameras. The evaluation device can be formed by a computer, in particular by a PC. The determination of the location or locations and/or of the orientation or orientations can take place by way of bundle block adjustment.

The invention further relates to an apparatus for determining the 3D coordinates of an object which includes one of the aforesaid apparatus for determining the 3D coordinates of an object and an industrial robot for positioning this apparatus.

It is advantageous if the apparatus includes a field of reference marks. The reference marks can be attached to one or more walls. It is, however, also possible to attach the reference marks in another manner. The wails to which the reference marks are attached can form a measuring cell for the object. The measuring cell can be closed or open.

In a method for determining the 3D coordinates of an object, the object of the invention is achieved in that the object is positioned before a field of reference marks, in that the object is completely or partly taken by an apparatus in accordance with the invention and in that one or more reference marks of a field of reference marks is taken by one or more reference cameras.

It is advantageous if further parts of the object are taken. Some or all shots of the parts of the object preferably overlap.

The invention finally relates to a method for measuring a field of reference marks, wherein an apparatus in accordance with the invention is positioned in a plurality of positions by an industrial robot, one or more or all reference marks are taken by the apparatus in these positions and the positions of the reference marks are determined from these shots. It is hereby possible to determine the positions of the reference marks by location and orientation.

The invention furthermore relates to a method for calibrating an industrial robot. In this respect, it is preferably a multi-axial industrial robot.

It is the object of the invention to propose an improved method for calibrating an industrial robot.

This object is achieved in accordance with the invention by the features of claim 10. In accordance with the method, an inventive apparatus for determining the 3D coordinates of an object is positioned in a plurality of predefined positions by the industrial robot. These positions can be predefined by their location and/or orientation. In these positions, one or more or all reference marks of a field of reference marks are taken by the apparatus. The positions of the industrial robot are determined from these shots. The positions of the industrial robot can be determined by their location and/or orientation. The predefined and determined positions of the industrial robot can be the positions of the most extreme arm of the industrial robot. The positions of the industrial robot which have been determined from the shots are compared with the predefined positions of the industrial robot. This comparison delivers a measure for the deviations of the actual positions of the industrial robot from the predefined positions. This measure can be taken into account as a correction value with positions to be predefined in the future. It is also possible to form a correction matrix from a plurality of correction values for different predefined positions, said correction matrix also delivering correction values for positions disposed therebetween, for example based on an interpolation. The interpolation can be carried out with different suitable functions.

The object of the invention is achieved in a method for calibrating an industrial robot in accordance with a further proposal by the features herein. In this method, an apparatus for determining the 3D coordinates of an object using a projector for projecting a pattern onto the object and using a camera connected to the projector for taking the object is positioned in a plurality of predefined positions by an industrial robot. A reference body is taken by the apparatus in these positions. The reference body can in particular be a ball. The positions of the industrial robot are determined from the shots. These positions are compared with the predefined positions of the industrial robot. It is possible to use an apparatus in accordance with the invention for determining the 3D coordinates of an object. In this case, the one reference camera or the plurality of reference cameras are not required. Reference is made in another respect to the above-described first method for calibrating an industrial robot.

A further resolution of the object of proposing an improved method for determining the 3D coordinates of an object is set forth herein. In this method for determining the 3D coordinates of an object, an apparatus for determining the 3D coordinates of an object using a projector for projecting a pattern onto the object and using a camera connected to the projector for taking the object is positioned by an industrial robot which has been calibrated in accordance with a method in accordance with the invention. The object is taken in this position by the apparatus for determining the 3D coordinates of an object.

This method makes it possible to use only the position of the robot for the global registration of the respective shot. This is in particular advantageous when it is not possible that the one reference camera or the plurality of reference cameras can take a sufficient number of reference marks. This can in particular be the case when the 3D coordinates in the inner space of an object, for example, of an automotive body, should be determined.

### BRIEF DESCRIPTION OF THE DRAWING

An embodiment of the invention will be explained in detail in the following with reference to the enclosed drawing. In the drawing the

only FIGURE shows an apparatus for determining the 3D coordinates of an object in a schematic representation.

### DESCRIPTION OF THE PREFERRED EMBODIMENTS

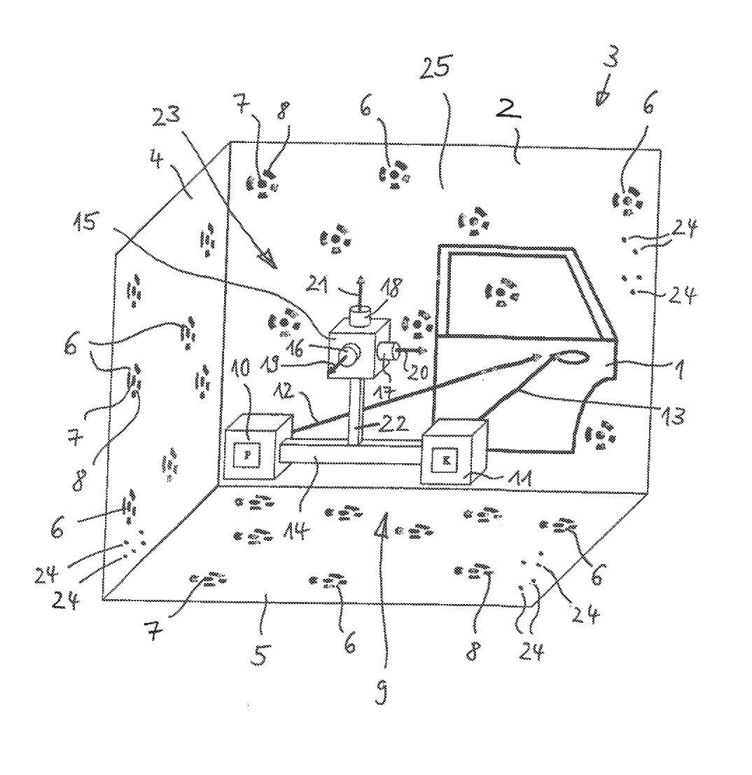

The measurement setup shown in FIG. 1 serves to determine the 3D coordinates of the front side of an object 1, namely of a motor vehicle door (body shell door). The object 1 is positioned in front of a rear wall 2 of a measuring cell 3. The measuring cell 3 includes the rear wall 2, the left side wall 4 and the base wall 5. The measuring cell 3 furthermore includes a right side wall, a rear wall and a top wall (not shown in the drawing).

Reference marks 6 which are intrinsically coded are arranged at the walls of the measuring cell 3, and reference marks 24 which are not intrinsically coded, but which are arranged spatially with respect to one another such that this spatial arrangement contains a coding. The reference marks 6, 24 form a field 25 of reference marks. Each reference mark 6 which is intrinsically coded includes an unchanging, non-encoding element and a changing, encoding element. The non-encoding element is formed by a circle 7 which is located at the center of the Coded reference mark 6. The encoding element 8 is formed by segment sections 8. In contrast to the representation in the drawing, the encoding element 8 is different in each coded reference mark 6. An unambiguous identification of each coded reference mark 6 is possible by the different encoding elements 8.

A light fringe projection system 9 is arranged in the measuring cell 3. The light fringe projection system 9 includes a projector 10 and a camera 11. A pattern, in particular a light fringe pattern, is projected onto the object 1 by the projector 10, as indicated by the arrow 12. The camera 11 takes the light fringe pattern radiated back from the object 1 in accordance with its spatial surface, as indicated by the arrow 13. The projector 10 and the camera 11 are connected to one another by a linkage 14. They are fixed in their location and orientation relative to one another.

A camera module 15 is connected to the light fringe projection system 9. The camera module 15 includes a first reference camera 16, a second reference camera 17 and a third reference camera 18. The optical axis 19 and thus the direction of gaze of the first reference camera 16 is directed to the rear wall of the measuring cell 3; the optical axis 20 and thus the direction of gaze of the second reference camera 17 is directed to the right side wall of the measuring cell 3; and the optical axis 21 and thus the direction of gaze of the third reference camera 18 is directed to the top wall of the measuring cell 3. The right side wall, the rear wall and the top wall of the measuring cell are likewise provided with reference marks 6, 24.

The camera module 15 is fixed in its location and orientation with respect to the light fringe projection system 9. It is connected to the linkage 14 of the light fringe projection system 9 via a linkage 22. The light fringe projection system 9 and the camera module 15 form a measuring system 23.

In a first measurement run, the positions of the reference marks 6, 24 of the measuring cell 3 are detected and saved. No object 1 is preferably located in the measuring cell 3 in this measurement run. The determining of the positions of the reference marks 6, 24 preferably takes place by way of photogrammetry. In this respect, shots of the reference marks 6, 24 are taken from different camera positions. This can be done by the camera 11. It is, however, also possible to carry out the photogrammetry of the reference marks 6, 24 independently of the light fringe projection system 9, it is in both cases possible, but not compulsory, to position the camera by an industrial robot.

After the determination of the positions of the reference marks 6, 24, the 3D coordinates of objects can be determined. The object 1 is positioned in the measuring cell 3 for this purpose, as can be seen from the drawing. The projector 10 projects a light fringe pattern onto the surface of the object 1; the camera 11 takes the reflected light fringe pattern; and one or more or all reference cameras 16, 17, 18 take reference marks 6, 24 of the field 25 of reference marks.

On the use of only one reference mark, it is generally necessary to detect at least three encoding reference marks 6 in a shot. On the use of three reference cameras, it is generally necessary that each reference camera detects at least one encoding reference mark 6.

In an evaluation device, in particular on a computer, in particular on a PC (not shown in the drawing), the location and orientation of the measuring system 23 is determined from the shot or shots of the reference marks 6, 24 which were taken by the reference camera(s) 16, 17, 18. It is hereby possible to determine the 3D coordinates of the object 1 from the shots of the camera 11.

If the object 1 is larger than the field of view of the camera 11, a plurality of shots of the object 1 must be taken. These shots can overlap one another in part, it is possible due to the taking of the reference marks 6, 24 by one or more reference cameras 16, 17, 18 to determine the 3D coordinates of the associated part surface of the object 1 as absolute coordinates for each individual shot of a part of the object 1 by the camera 11.

The apparatus furthermore includes an evaluation device for determining the location and orientation of the measuring system 23, that is, of the projector 10, of the camera 11 and of the reference cameras 16, 17, 18. This evaluation device can also be formed by a computer, in particular by a PC (not shown in the drawing).

The measuring system 23 can be positioned by an industrial robot (not shown in the drawing).

A method and an apparatus for the global registration of an object are provided by the invention. A measuring cell in which a robot system can operate is equipped with reference marks. The field of reference marks can be calibrated once photogrammetrically. The individual measuring shots for determining the 3D coordinates of the object can be transferred into the coordinate system of the reference marks.

One or more reference cameras 16, 17, 18 which look in different spatial directions are fixedly mechanically connected to the light fringe projection system 9 and are brought into a common coordinate system therewith by means of a suitable calibration. This calibration can take place in that the light fringe projection system 9 and the camera module 15 each measure a subset of the reference marks simultaneously, preferably several times. In a photogrammetric bundle block adjustment, the outer or relative orientations of the reference cameras 16, 17, 18 of the camera module 15 as well as of the projector 10 and of the camera 11 of the light fringe projection system 9 can then be determined together.

On the measurement of the object 1, that is, on the determination of the 3D coordinates of the object 21, the exact determination of the position and orientation of the light fringe projection system 9 takes place via the camera module 15 and the reference marks 6, 24, preferably in the process of a photogrammetric bundle block adjustment. The individual measuring shots of the object 1 can be transferred into a common coordinate system with the aid of this information.

Furthermore, a remeasuring of the field 25 of reference marks within the measuring cell 3 is possible. This can be done with the aid of a robot program and of the measuring system 23. In this respect, the coordinates of the reference marks 6, 24 known from the first measurement flow into the bundle block adjustment as approximate values.

It is furthermore possible to use the measuring system 23 to calibrate an industrial robot. When the positions of the reference marks 6, 24 have been detected and saved, the position of the industrial robot can be very exactly detected with the aid of the field 25 of reference marks and with the aid of the measuring system 23. It is, however, also possible to measure the industrial robot with the aid of a measurement of a reference body, for example of a ball, from different positions of the industrial robot.

In both cases, the required calibration information of the robot results from a comparison of the transformations of the reference measurements with the manually predefined positions in the robot coordinate system.

1. An apparatus for determining the 3D coordinates of an object (1) comprising a projector (10) for projecting a pattern onto the object (1); a camera (11) connected to the projector (10) for taking the object (1); and a reference camera (16) connected to the projector (10) and to the camera (11) for taking one or more reference marks (6, 24) of a field (25) of reference marks.

2. An apparatus in accordance with claim 1, comprising one or more further reference cameras (17, 18).

3. An apparatus in accordance with claim 1, wherein the reference cameras (16, 17, 18) are provided at a camera module (15).

4. An apparatus in accordance with claim 1, comprising an evaluation device for determining the location and/or orientation of the projector (10) and/or of the camera (11) and/or of the one or more reference cameras (16, 17, 18).

5. An apparatus for determining the 3D coordinates of an object, including an apparatus in accordance with claim 1 and industrial robot for positioning this apparatus.

6. An apparatus in accordance with claim 1, comprising a field (25) of reference marks.

7. A method for determining the 3D coordinates of an object (1), wherein
the object (1) is positioned in front of a field of reference marks (6, 24); the object (1) is completely or partly taken using an apparatus in accordance with claim 1; and one or more reference marks (6, 24) of a field (25) of reference marks are taken by one or more reference cameras (16, 17, 18).

8. A method in accordance with claim 7, wherein further parts of the object (1) are taken using the apparatus.

9. A method of measuring a field of reference marks (6, 24), wherein
an apparatus in accordance with claim 1 is positioned in a plurality of positions by an industrial robot; in that one or more or all reference marks (6, 24) are taken by the apparatus in these positions; and in that the positions of the reference marks (6, 24) are determined from these shots.

10. A method for calibrating an industrial robot, wherein
an apparatus in accordance with claim 1 is positioned by the industrial robot in a plurality of predefined positions; one or more or all reference marks (6, 24) of a field (25) of reference marks are taken by the apparatus in these positions; and the positions of the industrial robot are determined from these shots and are compared with the predefined positions.

11. A method for calibrating an industrial robot, wherein
an apparatus for determining the 3D coordinates of an object (1) comprising a projector (10) for projecting a pattern onto the object and a camera (11) connected to the projector (10) for taking the object (1) is positioned by the industrial robot in a plurality of predefined positions; a reference body is taken by the apparatus in these positions; and the positions of the industrial robot are determined from these shots and are compared with the predefined positions.

12. A method for determining the 3D coordinates of an object, wherein
an apparatus for determining the 3D coordinates of an object (1) comprising a projector (10) for projecting a pattern onto the object (1) and a camera (11) connected to the projector for taking the object (1) is positioned by an industrial robot which has been calibrated in accordance with a method in accordance with claim 10; and the object is taken by the apparatus.

13. An apparatus in accordance with claim 2, wherein the reference cameras (16, 17, 18) are provided at a camera module (15).

14. An apparatus in accordance with claim 13, comprising an evaluation device for determining the location and/or orientation of the projector (10) and/or of the camera (11) and/or of the one or more reference cameras (16, 17, 18).

15. An apparatus in accordance with claim 3, comprising an evaluation device for determining the location and/or orientation of the projector (10) and/or of the camera (11) and/or of the one or more reference cameras (16, 17, 18).

16. An apparatus in accordance with claim 2, comprising an evaluation device for determining the location and/or orientation of the projector (10) and/or of the camera (11) and/or of the one or more reference cameras (16, 17, 18).

17. An apparatus for determining the 3D coordinates of an object, including an apparatus in accordance with claim 16 and industrial robot for positioning this apparatus.

18. An apparatus for determining the 3D coordinates of an object, including an apparatus in accordance with claim 15 and industrial robot for positioning this apparatus.

19. An apparatus for determining the 3D coordinates of an object, including an apparatus in accordance with claim 14 and industrial robot for positioning this apparatus.

20. An apparatus for determining the 3D coordinates of an object, including an apparatus in accordance with claim 13 and industrial robot for positioning this apparatus.
